(19) United States
(12) Patent Application Publication
(10) Pub. No.: US 2006/0242549 A1
(43) Pub. Date: Oct. 26, 2006

(54) Method, computer programme product and device for the processing of a document data stream from an input format to an output format

(76) Inventors: Hartwig Schwier, Munich (DE); Werner Engbrocks, Poing (DE); Klaus Hirtenreiter, Eching (DE); Georg Landmesser, Haar (DE); Matthias Fromm, Markt Schwaben (DE)

Correspondence Address: SCHIFF HARDIN, LLP;PATENT DEPARTMENT, 6600 SEARS TOWER, CHICAGO, IL, 60606-6473, US

(21) Appl. No.: 10/532,870

(22) PCT Filed: Oct. 30, 2003
(86) PCT No.: PCT/EP03/12106

§ 371 Date: Jun. 16, 2006

(30) Foreign Application Priority Data
Oct. 31, 2002 (DE) 102 50 842.9

(51) Int. Cl. G06F 17/00

(52) U.S. Cl. 715/500

(57) ABSTRACT

In a method or system for conversion of an input data document data stream that corresponds to one of many possible input data formats into an output document data stream that corresponds to one of many possible input data formats, the input document data stream is converted into an internal data format. Document formatting information that establishes a representation of the data in the output format is added as needed to the data in the internal data format. The data are then converted into the output data format.

### BACKGROUND

The preferred embodiment concerns a method, a computer program product and a system for processing of document data streams. It in particular concerns a method and a system for processing a document data stream that is prepared for output on a printing device. Such a preparation typically occurs in computers that process the print files or print data adapted to the printer from user programs. The print data are thereby, for example, thus converted into an output stream of a specific printer language such as AFP® (Advanced Function Presentation), PCL™ or PostScript™. Data are, for example, output from SAP databank applications to the printer in the format SAP/RDI.

In mainframe centers, the print data are typically compiled in a host computer (main frame) and large print jobs (jobs) are generated from this that contain up to multiple gigabytes of data. The print jobs are thereby adapted for output on high-capacity printing systems such that the high-capacity printing systems are temporally optimally loaded in the production operation or can largely be used in continuous operation. The printout then occurs either via the host computer or via connected servers.

Such high-capacity printers with printing speeds of approximately 40 DIN A 4 pages per minute, up to 1000 DIN A 4 pages per minute are, for example, described in the publication “Das Druckerbuch”, published by Dr. Gerd Goldmann (Océ Printing Systems GmbH), 6th edition, May 2001, ISBN 3-000-00 1019-X. Concepts for high-performance preparation and processing of print data are described in chapter 14 under the title “Océ PRISMApro Server System”.

A typical print data format in electronic production printing environments is the format AFP (Advanced Function Presentation) which is, for example, described in the publication Nr. F-544-3884-01 by the firm International Business Machines Corp. (IBM) with the title “AFP Programming Guide and Line Data Reference”. In this publication, the specification for a further data stream with the designation “S/370 Line-Mode Data” is also described. The print data stream AFP was further developed into the print data stream MO:DCA, which is specified in the IBM publication SC31-6802-04 with the title “Mixed Object Document Content Architecture Reference”. No differentiation is made between AFP data streams and MO:DCA data streams in the present specification.

A data processing system with the trade name PRISMAproduction™ is offered by the applicant for high-capacity printing systems, which data processing system is in the position to process print data streams from various applications, to spool under various operating systems such as MVS™ or BS 2000™, and to convert into a device-oriented data stream such as, for example, IPDS™ (Intelligent Printer Data Stream).

The program that has become known under the designation ACIF™ has been created by the firm IBM Corp., with which program it is possible to convert and to index print data streams. The ACIF application is described in the IBM brochure G544-3824-00 with the title “Conversion and indexing facility application programming guide” as well as in the IBM brochure Nr. S544-5285-00 with the designation “AFP conversion and indexing facility (ACIF) user's guide”. Corresponding computer programs under the trade names SPS™, CIS™ are known from the applicant.

U.S. Pat. No. 6,097,498 appears to be for supplementation of commands in the print data language IPDS. Objects from other printing languages such as PostScript or PCL can accordingly be inserted and transferred into an IPDS data stream with a WOCC command. In the German patent application Nr. 102 45 530.9, it is also described how additional control commands can be inserted into a print data stream.

From the IBM publication Nr. S544-5284-06, “IBM Page Printer Formatting Aid: User's Guide”, 7th edition, which is, for example, accessible at http://publib.boulder.ibm.composite material/prsys/pdfs/54452846.pff, a tool is known with which a user can generate what are known as “form definitions” (formdef) and “page definitions” (pagedefs) for formatting of print data. A corresponding computer program SLE™ (Smart Layout Editor) is developed and distributed by the applicant.

From WO 01/77807 A2 or the corresponding DE-A1-100 17 785, a method for enhancement of document data corresponding to the product CIS™ cited above is known in which the document data stream is normalized, i.e. brought into a uniform data format, and index data are formed for a search or sort event. Furthermore, resource data that are contained in the data stream are extracted and merged into a resource file. Finally, the data can be sorted according to predetermined search criteria and a corresponding document file can be output.

In PCT/EP02/05296, it is described how a print data stream can be shown on a screen in rastered form.

A distributed printing system in which print jobs can be sent to various printers of a network from various inputs is known from EP-A1-0 982 650. When a print job is received in a print data language that cannot be interpreted by the provided printer, the print job is translated into a language with which the provided printer is compatible.

A method is known from U.S. Pat. No. 5,993,088 with which print jobs are first collected (spooling event) before they are output to a printer.

A method for output of document print data is known from DE-A1-199 11 461 in which variable data and static data are initially merged per document and are separated again before the transfer so that static data that occur in a plurality of documents only have to be transferred once.

Known methods for processing of print data are shown in FIGS. 2 and 3. The print data are thereby sent from a print data source 25 with a pattern data set to an editor such as, for example, the Smart Layout Editor (SLE) (which is distributed by the applicant). Using this pattern data set, the layout (forms, data placement, fonts etc.) is established for printout and an AFP resource data stream with a formdef file and pagedef file is generated. The AFP resource data stream 27 comprises only some kilobytes to a maximum of a few hundred kilobytes and contains forms, fonts, page definitions and form definitions as commands. The AFP resource data stream 27 is then sent to a print preparation computer (print server) and stored there. Given later printout of the print data, these are sent over to print data path 29 directly to the print server 28, which in turn links the print data with the AFP resource data stream and from this generates an IPDS data stream which is sent to one or more printing devices 31, 32 for printout.

This processing manner is thus based on the concept that a separation occurs between the variable data to be printed and the resource data stream. The advantages of this method based on AFP are a high processing speed and a high degree of compression, since the resource data can be transferred once as a relatively small file and the larger part of the data (print data) can be sent from the print data source 25 directly to the print server 28 without encumbering auxiliary information such as layouts, forms, fonts etc.

What is disadvantageous in this method based on the IBM product Page Printer Formatting Aid (PPFA) is that only print data provided in PPFA and predetermined formatting principles can be used. Although personalized documents can be generated via “conditional processing”, for this a new document page must be described for each bifurcation. The application design is thereby very protracted and complex. In particular, the generation of pie charts or bar diagrams is not possible in this manner. This would only be possible via special functions in a correspondingly expanded printer driver. However, the printout of such applications would therewith be limited to manufacturer-specific systems, which would be relatively disadvantageous.

Resources are static, meaning they are neither generated nor changed in the execution of a print job. Furthermore, they contain no print data; however, print data patterns can be used in the design of the resources.

A data preparation according to what is known as the formatter principle is shown in FIG. 3. The complete print data stream is thereby fed from the print data source 25 to a formatter 35 which creates a layout and directly integrates the layout specifications (such as form specifications, font form specifications and other format specifications) into the print data stream. The complete print data stream so prepared is then sent to the print server 28 and forwarded by this to a printer 31, 32. Such a processing corresponds to many methods established in what is known as the small office-home office (SOHO) field. For example, print data are processed in this manner in the Microsoft Office products WinWord™, Access™ and Excel™ under the operating system MS Windows™.

What is advantageous in this type of data preparation is that practically any complex instructions or rules can be integrated into the print data stream. In particular, tables with dynamic length are possible, including intermediate and final sums, as well as the graphic preparation of print data via pie charts or bar diagrams etc. In principle no limits are thereby set on the representation of print data. Additionally, different print data can be loaded via input filters, among other things also what are known as RDI data from databank programs by the firm SAP AG, Walldorf, Germany.

What is disadvantageous with this method is that that the print data stream is very substantial due the formatting specifications, and thus the transfer of the print data from one computer to another computer or to the printer takes a relatively long time. Furthermore, the print preparation must occur individually for each print job. Computer programs that apply this principle to AFP print data must generate a complete AFP data stream for each print job, even when no dynamic should occur. For printout, these AFP data streams are translated into corresponding IPDS data streams for the print devices. It is thereby disadvantageous that the smallest changes to print jobs compel a complete re-generation of the AFP data streams.

A high-performance processing and preparation of print data is in particular necessary in the printout of data from databanks. In databank applications that are distributed by the firm SAP AG, data can be output in what is known as the RDI format (Raw Data Interface format). The data can thereby be output partially formatted with the tool “SAP script” or also output unformatted.

### SUMMARY

It is an object to specify a method, a computer program product and a computer system with which large print data streams can, on the one hand, be flexibly prepared individually for a data set and, on the other hand, can overall be transferred with high performance.

In a method or system for conversion of an input data document data stream that corresponds to one of many possible input data formats into an output document data stream that corresponds to one of many possible input data formats, the input document data stream is converted into an internal data format. Document formatting information that establishes a representation of the data in the output format is added as needed to the data in the internal data format. The data are then converted into the output data format.

### BRIEF DESCRIPTION OF THE DRAWINGS

FIG. 1 shows a high-capacity printing system;

FIG. 2 shows the known method for processing of print data according to the AFP and IPDS specifications;

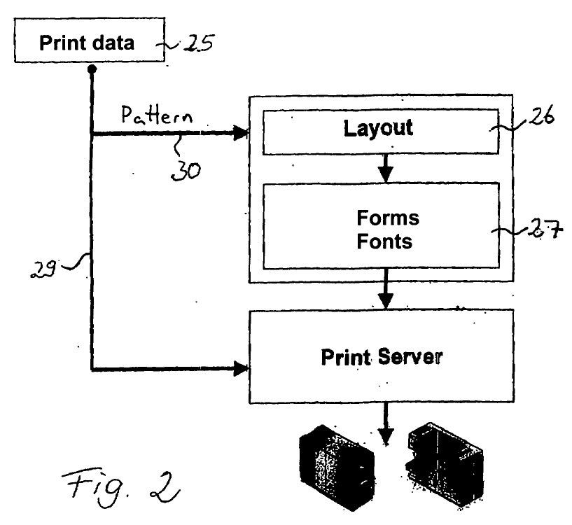

FIG. 3 shows the known method for processing of print data according to what is known as the formatter principle;

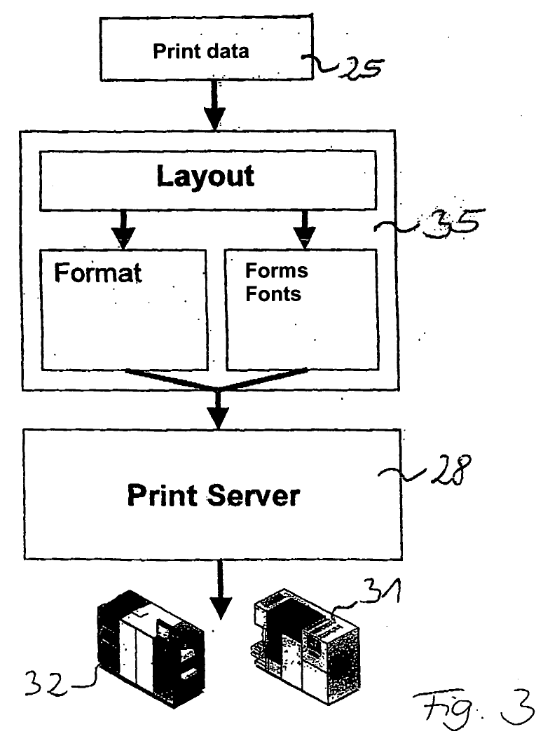

FIG. 4 shows the principle of the preferred embodiment;

FIG. 5 shows the application of the invention on a data processing system in which an SAP databank system cooperates with a print production system;

FIG. 6 shows the principle of a processing of the preferred embodiment with respective participating processing modules;

FIG. 7 shows a workflow of the preferred embodiment for design time from the view of a user,

FIG. 8 shows a workflow for design phase relating to document data;

FIG. 9 shows a workflow in the production phase relating to document data;

FIG. 10 shows the assembly of a complex document with components;

FIG. 11 shows the creation of a document with barcode from variable and static data;

FIG. 12 shows a method flow in which PCL document data are generated at the output side;

FIG. 13 shows various stations in which document data are incrementally connected to a document;

FIG. 14 shows expansions to the stations shown in FIG. 13; and

FIG. 15 illustrates a generalized method flow of the preferred embodiment.

### DESCRIPTION OF THE PREFERRED EMBODIMENT

For the purposes of promoting an understanding of the principles of the invention, reference will now be made to the preferred embodiments illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

According to a first aspect of the preferred embodiment, the input document data stream is translated into an internal data format for conversion of an input document data stream that corresponds with one of many possible input data formats into an output document data stream that corresponds to one of many output data formats. Document formatting information that establishes the representation of the data in the output format is added as needed to the data in the internal data format and the data are then converted into the output data format.

According to a second aspect of the preferred embodiment that can be viewed as independent of the first aspect of the invention, for conversion of an input document data stream that corresponds to one or many possible input data formats into an output document data stream that corresponds to one of many output data formats, the input document data stream can be translated into an internal data format (such as, for example, AFP, Unicode or PPML); data formatting information that establishes how the content of the data stream is represented in the internal data format is added as needed to the data in the internal data format and controlled by a document template that in particular describes the addition of formatting instructions in the internal data format; and finally the data are output in the output data format.

According to a third aspect of the preferred embodiment that can also be viewed as independent of the previously cited aspects of the preferred embodiment, for format-adapted and speed-optimized processing of an input document data stream, this is converted into an internal data format with formatted data that contain format specifications and raw data that contain no format specs. Formatting instructions are added to the raw data by means of predetermined rules and an output data stream that has a predetermined format is formed from the data of the internal data format.

According to a fourth aspect of the preferred embodiment that can also be viewed as independent of the previously cited aspects of the preferred embodiment, in a method for processing and preparation of document data streams in a first, preparatory processing phase a pattern data set (comprising a specific data structure) of a document data stream can be provided with formatting instructions, and from this formatting information can be formed. In a second, productive processing phase of the document data stream, using the formatting information data are added to all data streams whose data structure corresponds to that of the pattern data set and all remaining data are forwarded without modification.

All document data streams can be used as input and/or output data streams, for example AFP (Advanced Function Presentation), Line Data, CSV (comma separated value), ODBC (Open Database Connectivity), Extended [sic] Markup Language (XML), Hypertext Markup Language (HTML), Extensible HTML (XHTML), Personalized Printer Markup Language (PPML), PostScript, Printer Control Language (PCL), SAP RDI (Raw Data Interface), Windows Meta Code, etc. In particular AFP and PPML are suitable as an internal data format, however a different data format (for example XML) can also be used.

The preferred embodiment is based on the realization that the various previously-cited data streams have respective advantages and disadvantages and that it would have to succeed to respectively use the advantages of the respective data streams and to correct the disadvantages via assumption of processing principles from other data streams. In particular, the advantages based on resources can be used with the preferred embodiment. Resources created once are neither generated nor modified in the execution of a printing event. It is therefore sufficient to transfer them once to a print server or printer and to then apply them multiple times to the respective print data. The possibility already described above for the query of print data and the program bifurcations also exists in the preferred embodiment. Furthermore, the relative positioning of print data is possible by linking of print data. The resources only have to be created once and can be used arbitrarily often, namely for all print data that have a structure that corresponds to the formatter printing data set used for creation of the resources.

Furthermore, the transfer to various printer models (IPDS) is possible since at most the description of the physical page (for example the formdef resource file in an AFP data stream) must be exchanged. Due to the device independence of an intermediate format, it is also possible that no format instructions based on a device-specific format are necessary.

On the other hand, advantages known from the formatter principle can also be used with the preferred embodiment, namely the possibility to integrate practically any representation instructions of the print data directly into the data stream. Such prepared print data are thereby in particular left in their formatted state and thus sent to the print server or printer.

Thus a high flexibility in the layout design of print documents is achieved with the preferred embodiment such that a fully-dynamic document structure is enabled. Both a dynamic layout (meaning the positioning and representation of document portions dependent on the print data on which they are based) and the integration of layout or formatting features from external sources (programs) can therewith occur. Furthermore, constant and variable data can be mixed, for example in continuous text and barcodes. Due to the device-independent processing of the document data within the process, it is possible to optimally output a design to different output devices, whereby the respective output data stream occurs adapted to a printer and/or adapted to a format.

According to the preferred embodiment, this is managed in that the method known from the AFP field and oriented towards resources is applied to what is known as raw data that are available unformatted in the input data stream, whereby one and the same formatting event is implemented for a plurality of data sets. Furthermore, the preferred embodiment is based on the realization that data sets that are already formatted structured for the most part require no modification and can be directly forwarded. However, in special cases it can also be provided that another additional formatting based on resources is to be added (what is known as Huckepack formatting) to a formatter formatting already contained in the data stream.

In an advantageous embodiment of the invention, the input data format, the output data format and/or the document formatting information to be added can be selected. This can in particular occur during a design phase during which the document template used for control of the supplementary formatting can also be generated or modified according to the second aspect of the preferred embodiment.

Furthermore, it is advantageous when, for the further processing, the data of the input document data stream are divided into pre-formatted data that already exhibit document formatting information and raw data that exhibit no document formatting information. The pre-formatted data are preferably processed in a first formatting stage in which they are in particular not modified, and the raw data are preferably processed in a second processing stage in which the document formatting information (corresponding to a document template generated using a pattern data set) is added to them. The raw data can thereby be associated with objects, whereby the objects can in particular comprise graphical elements such as, for example, pie charts, bar diagrams, borders, tables and/or colors.

The document formatting information can in particular comprise paper reproduction information such as, for example, N-up and/or duplex. Furthermore, it is advantageous to the use of a document template that it is independent of the format of the input document data stream and thus can be used independent of format. Document templates in particular access the design data set. Their use is therefore less error-prone given the expansion of lines, etc. than, for example, with pure line data.

Furthermore, the document formatting information can contain print pre-processing and/or post-processing information. In particular an Advanced Function Presentation data stream is provided as an output data stream in which a first group of formatting information is provided via a pagedef file and a second group of formatting information is contained in the variable data stream.

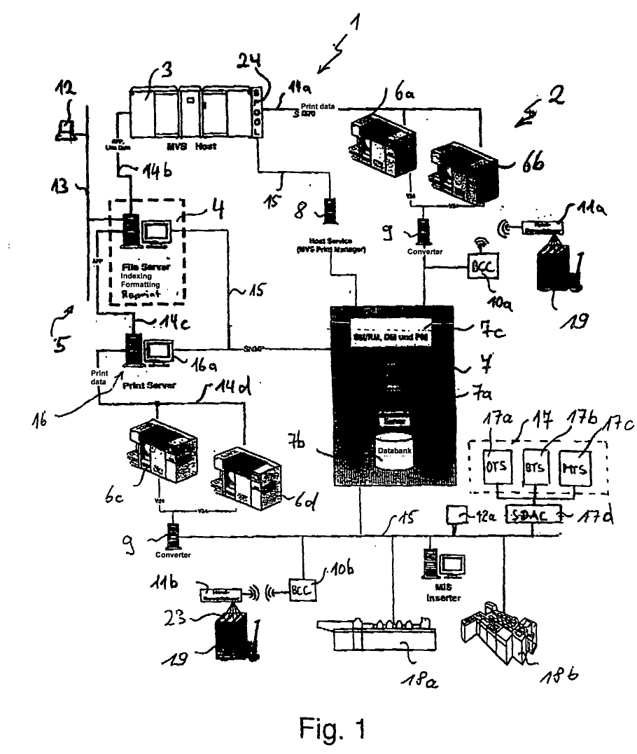

A document print production system 1 is shown in FIG. 1 that, on the one hand, comprises a mainframe architecture 2 and, on the other hand, comprises a network architecture 5, which document print production system 1 document data or document print data streams are generated by means of user programs (tools). These print data are generated by a host computer 3, for example as an AFP print data stream or as a line print data stream, in the mainframe architecture 2. The print data can alternately be sent by the host computer 3 directly to one or more print devices 6a, 6b via what is known as an S/370 channel 14a. As an alternative to this output channel, the print data can also be transferred from the host computer 3 over a network 13 or a direct data connection 14b to a processing computer 4 in which the print data are cached (for example in an associated file server) and be processed for subsequent output steps. In particular print data streams can be generated in such host computers 3, which print data streams are assembled from larger databases (databanks) of regular list expressions, accounts, consumption overviews (for telephone bills, gas bills, bank accounts) etc. Such applications have frequently already been in use for many years and are still required in a more or less unchanged manner (what are known as legacy applications).

The print production workflow is monitored by a monitoring system 7 within the mainframe architecture 2. The monitoring system 7 comprises a monitoring computer 7a that is coupled with a databank 7b and various computer program modules 7c.

The monitoring system 7 is connected with the host computer 3 via a device control network 15 and a print manager module 8 as well as via a converter 9 with, for example, a V24 data line that couples to both print devices 6a, 6b. The converter 9 translates the V24 signals into DMI protocol signals of the device controller network 15. SNMP protocol signals can be provided to the device manager DM translated as DMI protocol signals or be directly transferred as SNMP protocol signals.

A print good 19 that has been generated in the printers 6a, 6b from the document print data stream and on which barcodes are printed can respectively be scanned with a manually-movable radio-controlled barcode reader. The signals are transferred to the read station 10a via radio and transmitted into the device controller network 15 or to the monitoring system 7. Readers for a one-dimensional and/or two-dimensional barcode system can be used as barcode readers, such that various barcode systems can be read with one and the same reading device. The barcode reading system is in particular configurable, i.e. can be adapted to various application-specific codes or to the respective suitable control method.

Document data are generated in the network architecture 5 by means of user programs in client computers 12, 12a that are connected among one another as well as with the processing computer (file server) 4 via a client network 13. The file server therewith serves as a central processing and handling interface for print data of the entire print production system 1. Diverse control modules (software programs) run on it, via which control modules the entire print production workflow or the entire document processing can be optimally adapted (application-specific, production-related and on the device controller side) to the respective condition.

In particular the following functions are executed in the file server that are described more precisely with subsequent Figures:

1. Converting Indexing Sorting

In this function, incoming print data are converted into a uniform data format, indexed according to predetermined parameters and re-sorted in a predetermined sorting sequence. This in particular enables the re-sorting of the data streams optimized for the subsequent document output, for example the merging of various pages that are not in succession in the input data stream to be sorted together into a mail piece, such that they can, for example, be enveloped together into a correspondence (for example in an enveloper 18b).

2. Insertion of Control Information

In this function, control information, in particular barcodes, are inserted into the data stream, using which control information a data group belonging together (for example page, sheet, document, mail piece) can be recognized as such and be unambiguously localized in the production process at the various processing stations. The insertion can occur with a method or a computer system and a software that are described in the German patent application NR. 102 45 530.9.

3. Data Reduction

With this function, control data that have been delivered in the input data stream from the host computer 3 or user computer 12 to the processing computer 4 can be filtered to the effect that such control data that are not necessary in the given overall system arrangement are removed. Via the connection of all participating output devices (printers 6a through 6d, cutter 18, enveloper 18b) via the device controller network 15, it can already be decided in the processing computer 4 which control data of the input data stream are needed by none of the connected devices. Via removal of this data from the data stream, the data stream can be reduced overall, in particular when only empty field entries regarding corresponding control data are contained in the input data stream.

4. Extraction

With this function, predetermined data can be filtered or separated out from the output data stream, whereby a compressed data stream (compressed data) is created, in particular for control and status data, that can be exchanged with very high speed between the participating devices and the monitoring computer. It is hereby possible to execute the monitoring of the participating devices in real time.

The functions 1.-4. can largely be automatically implemented by a computer program module “CIS” (Converting, Indexing and Sorting), which is dealt with in detail again later.

5. Repeated Print (Reprint)

When, in the course of the further processing of the data, in particular in the output of the data on one of the print devices 6a, 6b, 6c or 6d, an error occurs in one of the post-processing devices 18a, 18b or also in the print computer 16, this can be determined by the monitoring system 7 using the control barcodes inserted into the processing computer 4, and the reprint of the documents (pages, sheets, mail pieces) affected by the malfunction can be requested. This reprint request is significantly controlled in the processing computer 4.

Print data that have been completed by the processing computer 4 are conveyed via the print data line 14c to a print server 16. Its task is essentially to unload the processing computer 4. This occurs via buffering of the completed print data until its recall over the data line 14d to one or both printers 6c, 6d. The print server 16 is thus integrated into the overall system predominantly for reasons of performance (speed). In systems whose print speed is less high, the print server 16 can also be omitted.

Document data that are transferred to the printers 6c or 6b and there are printed on a recording medium (for example paper) are, in the overall system, supplied to further processing steps, namely the cutter 18a and the enveloper 18b of the further processing. The print production process is therewith concluded.

The printed documents are tested with a test system 17 with regard to various criteria on their processing path between the print device 6 and the last post-processing device 18b, namely via an optical test system 17a with regard to their optical print quality, with a barcode test system 17b with regard to their existence, their consistency and/or their sequence, as well as with an MICR test system 17c insofar as the print was printed by means of magnetically-readable toner (magnetic ink character recognition toner). The data of the various test systems provided by the test system 17 are transferred from a mutual, serial data acquisition module 17d to the device controller network 15 and supplied to the monitoring system 7. There the respective system data are acquired and the devices are checked in real time, and the respective positions of the documents are tested with regard to their correctness relative to the print job.

Further details of such a test system 17 are specified in the U.S. Pat. No. 6,137,967 or in the patent application corresponding thereto. The content of this patent or these patent applications is herewith incorporated by reference into the present specification.

The finished printed documents 23 can in turn be registered with a barcode reader 11b that is connected, radio-controlled, with an associated control device 10b, which in turn delivers its data to the monitoring system 7 via the device controller network 15.

From PCT/EP02/05296 a system is known with which documents that are printed out on a printing system are shown on a screen in exactly the same manner as on the printing system, in that one and the same raster process is used both for display and for printing.

The content of the patents, patent applications and publications described above is herewith incorporated by reference into the present specification.

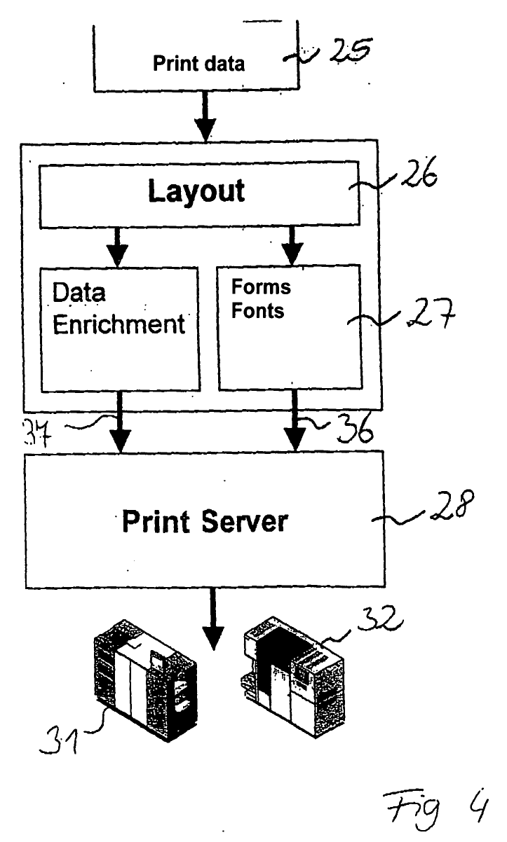

A procedure of the preferred embodiment is illustrated in FIG. 4. Static resources are created with the aid of the layout editor using a complete print data pattern. These are the standard resources known in the AFP data stream, such as overlays, page segments, fonts, pagedef and formdef files. However, print data that are not contained by means of the standard formattings offered in the AFP function spectrum are, however, written not into an AFP resource file but rather into an expanded print data file containing all variable print data. This file is drawn upon for individual design with particular formatting elements, for example graphical elements such as pie charts or bar diagrams. For this, the editor 26 is supplemented such that such formattings can be implemented. The basic concept of the AFP data structure, namely the data separation between variable and static data, is thereby nevertheless largely maintained. From the formatter principle, it is retained that the print data are completely transferred to an intermediate stage. In this intermediate stage—as provided in the processing of AFP print data—resources are associated with the print data and thus forms, fonts, etc. are standardized and converted into a relatively small AFP resource data stream. This resource data stream is transmitted over an AFP channel 36.

Furthermore, those data that are already otherwise formatted or in which no high-performance conversion or association of AFP resources is possible are sought out from the variable print data. These print data are accordingly supplemented with the necessary commands (data enrichment). This print data enrichment occurs in what is known as the design phase by means of a suitable editor, in that corresponding pattern data sets are examined and corresponding associations are made. For example, a data table could be called on and associated with the command that a pie chart is to be generated as a graphic element from the numbers located in the data table. A suitable new computer program or an already-existing editor for a specific printing language (for example an AFP editor such as the aforementioned Smart Layout Editor (SLE) by the applicant) can alternately be provided as an editor in order to enrich corresponding functions.

In a productive phase, i.e. while the variable print data stream is transferred from the data source 25 to the print server or directly to one of the printing devices 31, 32, the correspondingly enriched print data stream is sent to the print server or printer over the data channel 37. In the print server 28 or printing devices 31, 32, the prepared print data stream is combined with the AFP resources transmitted once, and ultimately the so-combined data stream is sent to the printer as an IPDS data stream. A printout can also occur as a telefax to a fax device, the data can be sent as an e-mail via an e-mail computer (for example via the client computer 12), or be placed on the Internet via a WWW server.

On the one hand, with the preferred embodiment it is thus possible to transfer standard data with high performance because these data are not overloaded by formatting instructions, and on the other hand those data formats which cannot be described or can only be laboriously described in AFP are to be sent to the print server simply and quickly.

In the method of the preferred embodiment, it is therewith provided to supplement processing methods known from AFP environments with at least one functionality via which formatting instructions (such as the representation of graphic data, for example the conversion into pie charts or bar diagrams or the addition of components such as barcodes, images and other objects) can be transferred within the print data.

An advantage of the solution of the preferred embodiment is thereby, on the one hand, the operating compatibility with the known fields and, on the other hand, the possibility to be able to furthermore use existing always-recurring print jobs. Thus a 100% backwards-compatibility of the method can be ensured in print production environments. Print data streams that have been generated under earlier editors, such as (for example) line data streams, can furthermore be transferred to the print server or printer directly via an enriched layout or editor module. Only a pagedef file that was generated earlier is assumed into a document template for this.

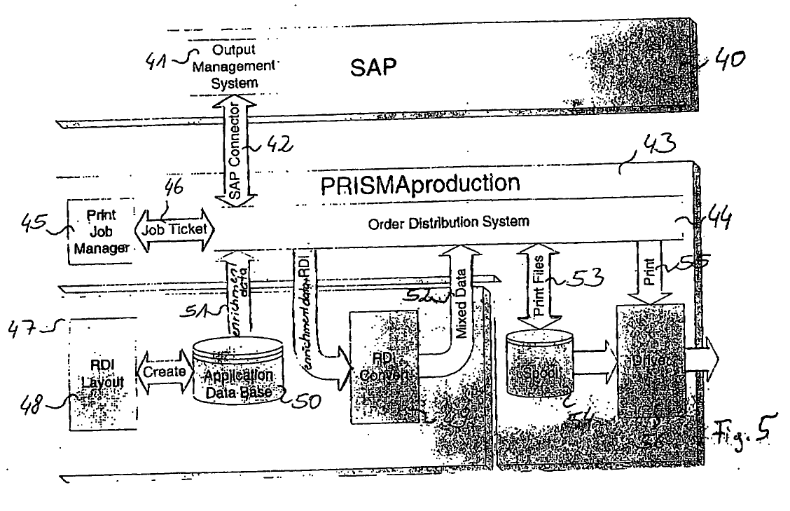

In FIG. 5, it is shown how computer program products of the preferred embodiment interact such that data that originate from an SAP databank application are prepared with formatting information and are prepared in a print production system such that they can be sent to a print device. Print data are sent from the SAP databank application 40 to a print production system 43 via an output data management system 41 (output management system) and an SAP interface 42 (SAP connector). Print jobs there are administered by a job distribution system 44 (order distribution system) for the further processing. Each print job is thereby individually identified by means of a print job manager 45 and provided with print job data, for example for a desired output printer or a certain priority. These data are located in a print job corollary file 46 (job ticket). A data enrichment module 47 serves for preparation of print data from a user databank. This data enrichment module 47 comprises two computer program modules 48, 49 that are necessary at various points in time.

In a data preparation phase, the data of a pattern data set are drawn from an application databank 50 (for example SAP databank) and suitable formatting and other enrichment data are appended to the pattern data set by means of the designer module 48 in order to prepare this according to the desire of the user. Suitable enrichment data 51 are then transmitted to the document generator computer program 49 via the job distribution system 44. With the document generator computer program 49, the RDI data as well as the associated formatting data are additionally converted into an internal, predetermined print data format linked with a printing system or selected by a user. The conversion can thereby, for example, occur into an AFP data stream, a PCL data stream, a PostScript data stream or also a PDF data stream.

The computer program module 49 uses the enrichment data in a second processing phase in which the complete databank data are transmitted from the SAP databank application 40 via the SAP interface 42, data set for data set to be enriched with the enrichment data. Personalized documents 52 are created in this manner, that are output via the job processing system 44 as print files 53 to a collection program 54 (spool) or as direct print data via a printer driver module 56 to a printer (not shown in FIG. 5).

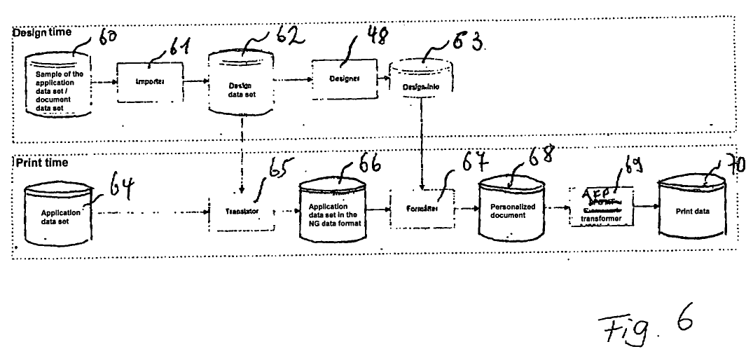

The data processing events are shown in FIG. 6 that are implemented on the one hand in the preparation phase (design phase) and on the other hand in the productive phase (print phase) in order to be able to prepare print data from arbitrary sources. For the design phase, a probe data set or, respectively, a probe document 60 is loaded as a design data set 62 into the designer computer program 48 via an import module 61. Arbitrary formatting or, respectively, enrichment information are added to the design data set 62 using this program 48, and thus the design information file 63 is formed. For the printing phase, application data sets 64 are read in, data set for data set, and translated into an internal AFP data format 66 by means of a translation computer program module 65 of the document generator computer program 49. From the application data set 64, the translator 65 forms the application data set in the internal data format 66 to which a computer program module “formatter” of the document generator computer program 49 is then applied.

The formatter computer program module 67 generates the personalized document 68 from the print data in the internal data format and the formatting rules defined by the design process, which formatting rules are stored in the design information file 63. A data transformation module 69 (AFP transformer) converts the personalized document file 68 into a print file 70.

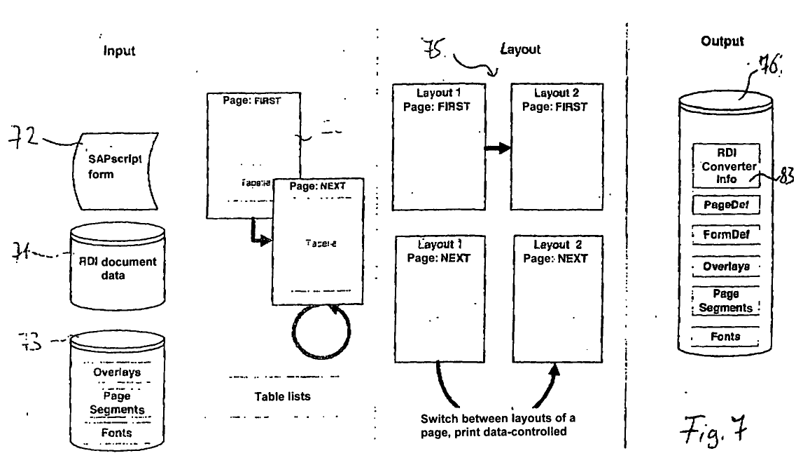

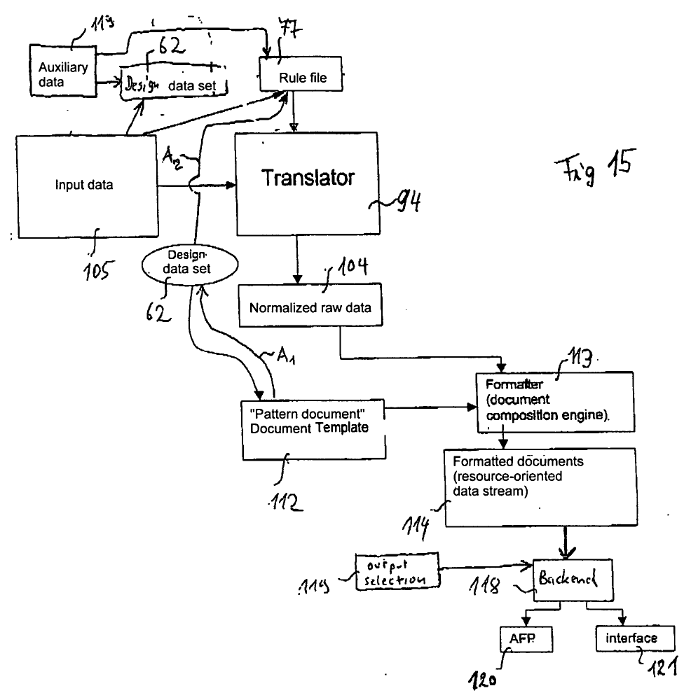

Which functions can be executed with the designer computer program 48 (compare FIG. 5) is shown in FIG. 7. SAP-RDI document data 71 as well as the SAP-RDI form 72 used in their generation are accepted as input data signals. Furthermore, overlays, page segments and font data 73 from AFP environments are accepted. Page queries as well as table positions 74 can be defined from table lists with the designer computer program 48 during the preparation phase. Furthermore, layout associations 75 can be established and it can be provided that a page is switched (controlled by print data) between layouts. On the output side, resources 76 are then provided in which information is contained about the type of the RDI conversion 83, the AFP resource files, pagedef, formdef and overlay as well as the page segments and the fonts which were provided on the input side. The RDI conversion information 83 contains the design data set 62, the information of the rule file 77 and the document template 112 (see FIG. 15).

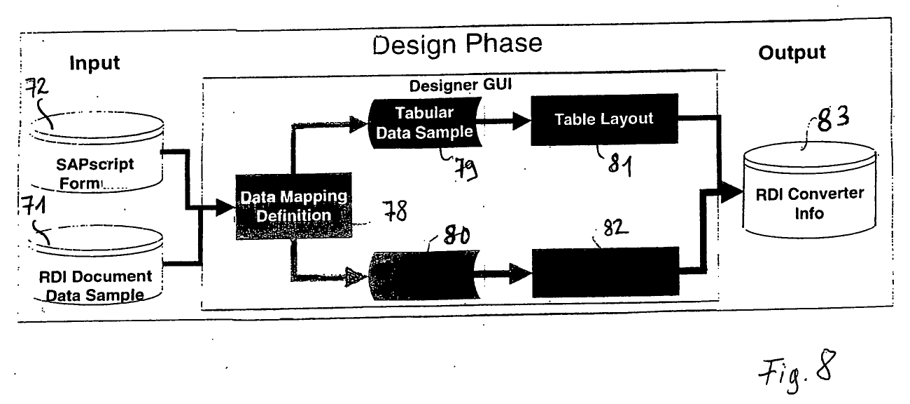

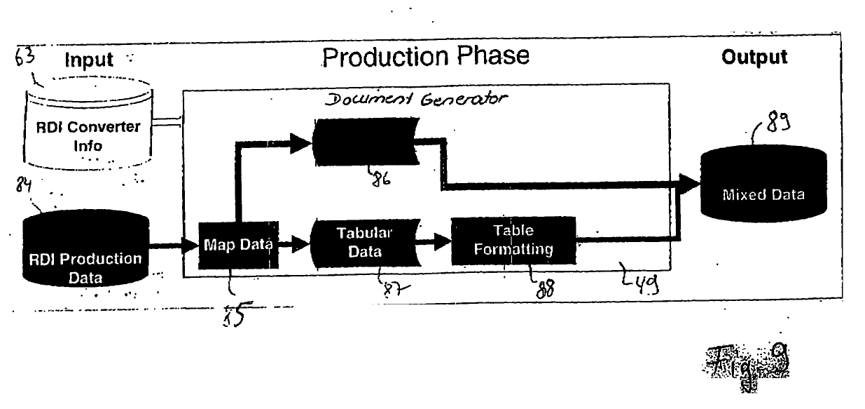

Both preparation phases (design phase and production phase are shown again in FIGS. 8 and 9 with their respective workflow. On the input side, in the design phase (FIG. 8) both files (RDI document data 71 and SAP script form 72) are read in, and in a data selection event 78 the data are separated, pattern by pattern, into typical pattern table data 79 and into pattern line data 80 that are associated with no tables. The line data 80 are then subjected to a typical line data process, meaning they are formatted as line data, whereby a line data layout 82 is generated, for example a specific graphical reproduction (such as a pie chart) is established. A table layout 81 is derived from the typical table data 79, whereby they can be enriched with additional formatting instructions for the page formatting. Both table layout and also page layout can receive fonts associated generally or region-by-region. The design information file 83 is created as an output file from this information. It contains a design data set 62 and the design information 63 (see FIG. 6) which are necessary for normalization of the data set and for formatting of the normalized data stream. In the production phase (FIG. 9), the design information file 83 is read in together with the RDI production data 84. In a data separation event 85, the line data 86 are separated from the table data 8, the table data 87 are formatted by a table formatter module 88 and the data are output by the document generator computer program 49 as an AFP data file 89 (mixed data).

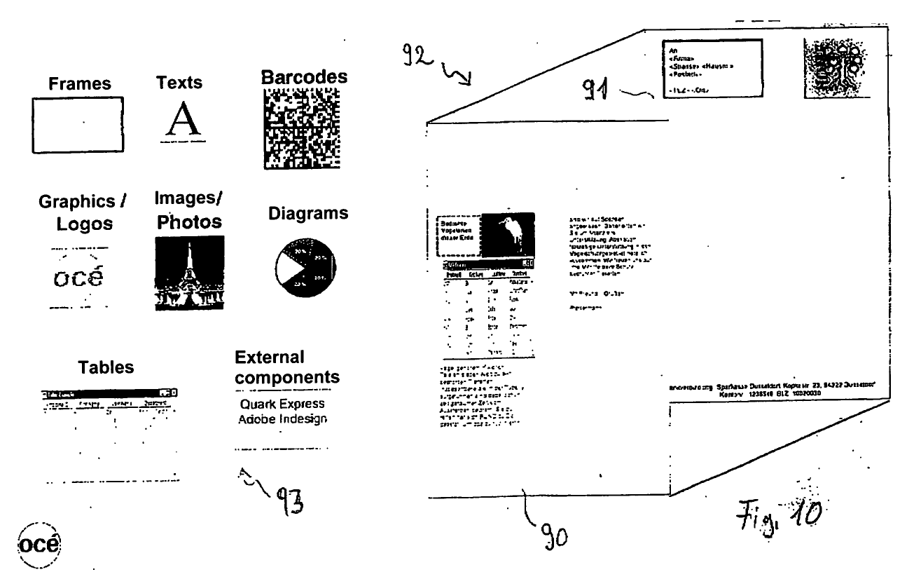

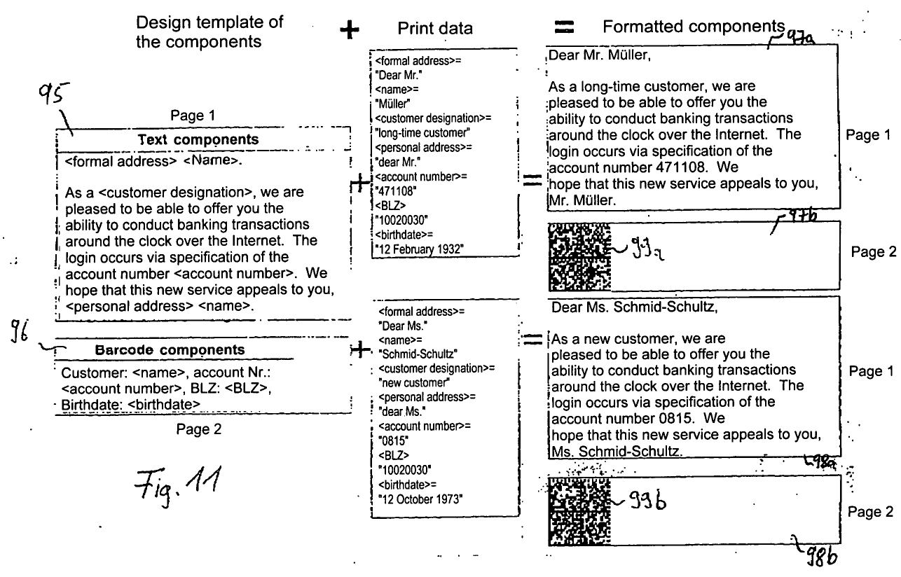

FIG. 10 shows a document 92 that is assembled from two components, namely a static frame page 91 and a dynamic page 90 with variable length of the information contained therein. Components 93 of various types can be provided in both pages, such as, for example, borders, texts, barcodes, graphics and logos, images and photos, diagrams, tables and external components that are generated by external program modules (such as the programs Quark Xpress™ and Adobe Indesign™) and in particular exhibit dynamic (i.e. variable) length. Such documents can be generated very flexibly and dynamically (meaning with variable length) with the invention. This primarily has a positive effect with tables, diagrams (such as pie charts or bar diagrams) as well as on elements of external components. This is clear in the example that is shown in FIG. 11. There it is respectively shown how a text component 95 interacts with a barcode component 96 and various print data. Constant and variable data are therefore respectively processed in different manners. The static parts of the text components 95, i.e. those that are not marked in angular brackets, are thereby reproduced in plain text on the respective first pages 97a, 98a of both documents, while the dynamic text portions situated in angular brackets are replaced by the print data. In contrast to this, in the barcode components both the static text portions and the dynamic text portions are used in order to generate a two-dimensional barcode on the page 2 of the first document 97b and of the second document 98b. Due to the classification of the document elements into various components, in productive operation the document generator computer program 49 can therefore decide which data are to be reproduced and for which data, under the circumstances, sub-programs must be invoked that further process the components. For example, the barcode component data are transcribed to a barcode generation module in which the barcodes 99a, 99b mapped in the document regions 97b and 98b are returned.

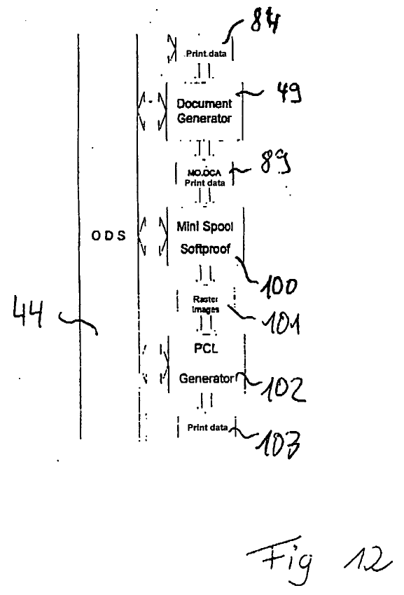

FIG. 12 shows how, in the system environment of FIG. 5, a print data stream is initially enriched and converted into an AFP print data stream and converted again into a PCL format for output. The central control module is thereby the job distribution system 44 (order distribution system). Unformatted or only partially formatted print data (for example RDI data) are thereby prepared by the document generator computer program 49 and, as described in FIG. 9, output in an AFP print file 89. These AFP print data can then be converted into raster images 101 with a minispool program 100 with softproof. These raster images are finally output embedded in a PCL data stream 102 and as a print file 103. Since this procedure focuses on the AFP print data specification and the softproof can be implemented such that it rasters in precisely the same manner as an IPDS printer, a print output comparable with AFP and essentially identical is achieved. A corresponding softproof method in which one and the same raster process is used for a preview and for a print event is, for example, described in PCT/EP02/05296 (submitted by the applicant). The content of this patent application is herewith likewise incorporated by reference into the present specification.

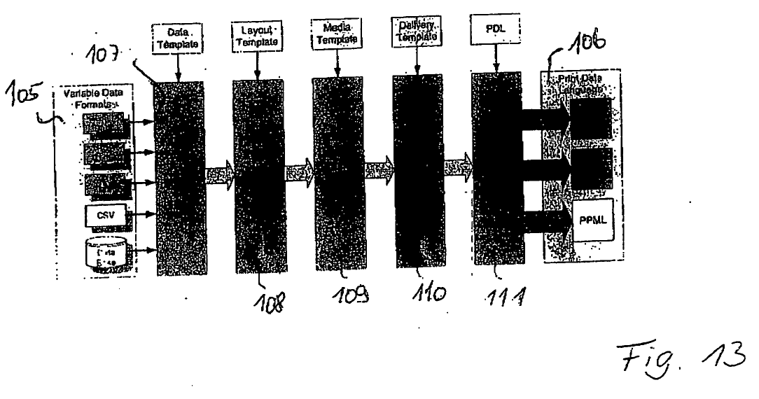

The rastered softproof image can furthermore be edited either directly or indirectly via the corresponding normalized data, such that the document (including its table data) can be modified individual to the user on a display medium (for example screen 16a) in a WYSIWYG (what you see is what you get) representation, whereby the document template is changed and therewith a reaction occurs on the normalized output data stream. In FIG. 13, it is shown how a document input data stream 105 that corresponds to one of many input data formats (such as line data, RDI data, XML data, CSV data or databank data) is converted into an output data stream 106 that corresponds to one of many possible output data formats such as, for example, AFP, PCL, PPML. In a step 107, the input data stream 105 is thereby converted into an internal data format. The encoding of the input data stream is in this case converted into a Unicode coding (mapping event to Unicode). Document formatting information is then added to the data stream in a formatting step 108. In a last step 11, the data are then converted into the selected output data format.

The formatting of the data in the step 108 can in particular occur in the previously shown manner, in that the data and/or formatting information to be inserted are inserted using components, meaning placeholders for specific information. In an additional step 109, page-specific information can be added to the data, for example in which manner the page should be put down on paper (N-up, duplex or the like).

In further document-specific formatting steps 109, 110, [sic] and document-specific information (such as formation of signals or imposition schemata, impositioning, resorting events, barcode insertion, etc.) can be added to the print data page. Furthermore, it is possible to effect an output directly from a device-independent, normalized output data stream to a display medium (screen, etc.), whereby a specific activation module is provided for the display medium or, respectively, for a computer system deploying a display medium, for example with a Windows API or a coupling to a browser under Windows or Linux. The task steps cited above are respectively controlled by what are known as templates. It can thereby be provided that further templates are used, also via an interface to external programs such as Océ Professional Document Composer (PDC), Océ CIS (Converting indexing sorting), Adobe® Indesign or a barcode generation module.

The output-specific conversion 111 can in particular occur in a printer-specific language. Furthermore, the internal print data format can be an AFP print data format, whereby it is only necessary to collect (spool) AFP data when they should be output on an AFP-capable output device. A conversion into other languages (such as PCL or PPML) can thereby also occur, whereby an embedding in raster-ed images can occur (see above) or a direct conversion of language levels.

With the arrangement shown above, it is possible to design all processing stages lying between the input data stream and the output data stream independent of a device. In the output side, the data can then be alternately be output device-dependent or likewise as a device-independent data stream. A device-dependent data stream can, for example, be output in the formats MO:DCA, PCL, PostScript or PDF.

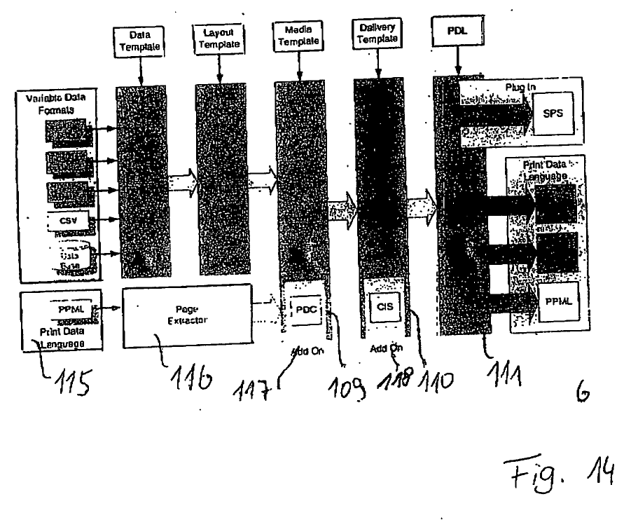

The FIG. 13 is again expanded with a few function elements in FIG. 14. Data 115 that are provided at the input side in the format Personalized Printer Mark-up Language (PPML) can be directly transferred into the page-specific formatting procedure 109 by means of a page extraction module 116. An imposition program 117 (PDC) can be set on the page-specific formatting module 109 for preparation of the pages for a signature printing. For re-sorting and/or insertion of barcodes or indexing elements, a further processing module 118 can be set on the document-specific formatting module 110. A forwarding by a mail module or a network connection module is also possible.

An inventive method flow is shown again in general in FIG. 15. A translation module 94 that is controlled by the rule file 77 serves for conversion of the input data 105 into the normalized data 104. The rule file 77 contains mapping rules that are formed in the design phase from the input document data 105 and/or from an (if applicable) design data set 62 to be newly created and/or from input data-specific auxiliary files 119. Both the design data set 62 and the rule file 77 can be freely edited. The design data set 62 can be formed from the input document data stream, 105 and/or from input data-specific auxiliary files 119 and additionally be used in the formation of a document template 112 that controls the formatting of the normalized data stream 104 (in stage 113). As shown with the arrows A₁ and A₂, the design data set 62 (and from this the rule file 77) can also be generated from the document template 112.

As an alternative to this, the rule file 77 can also be acquired directly from the input document data stream or other file information from the auxiliary files.

The mapping rules specified in the rule file 77 are specific for the input document data stream 105. They specify which element of the input document data stream 105 is to be associated with which element of the design data set. The design data set 62 contains the structure definition of the normalized data, whereby type declarations are provided for various structure elements, for example for customer numbers, names, logos, etc. Data groups that belong together, in particular all those data that belong to a document, can then also be formed in the normalized raw data 104. Thus all associated data are available in the normalized raw data stream 104 for each document. A document template 112 serves as a structure template for the documents to be generated and describes which formatting instructions are to be added into the normalized data stream. It can contain elements from the design data set 62 and/or contain free programmed static or dynamic elements 96, 93, 15 (see FIG. 10). The document template 112 is thus document formatting-dependent and serves to control the format formation device 113 (formatter or document composition engine). A resource-oriented data stream is formed per document by the formatter 113 from the normalized raw data stream 104. Insofar as formattings are already contained in the raw data these are retained, and insofar as the raw data are unformatted and formatting specifications regarding the corresponding data fields are contained in the document template, these are added resource-oriented in the formatter 113, whereby resources that are required multiple times within a data stream are further processed optimized for high performance, i.e. are inserted into the resource-oriented data stream mainly via invocation of the resources, whereby the resources themselves are only internally present once or can be externally loaded from a resource file or also just referenced. For processing of document template 112, design data set 62 and rule file 77, it can be advantageous to couple these files in the manner that a modification in one of the files leads to a consistency check and, if applicable, modification in both other files.

The formatted document data stream 114 is then supplied to a backend device 118 in which it is alternately prepared as a print data stream 120 in the output language (controlled via an output selection file 119) or via an interface 121 for an output device (telefax, e-mail server, WWW server, monitor). The normalized data stream 104 and/or the formatted data stream 114 can likewise already be optimized device-specific.

The invention was described using exemplary embodiments. It is thereby clear that the average man skilled in the art can specify modifications at any time. In particular, the cited print data languages are only to be understood as exemplary, since these are constantly further developed, as is apparent at the application point in time of the present application for the two print data languages Extensible Mark-up Language (XML) and Personalized Printer Markup Language (PPML).

The preferred embodiment can in particular be realized as a computer program that effects a method flow in a procedure on a computer. It is thereby clear that corresponding computer program elements or computer program products such as, for example, data media, volatile and non-volatile storage that store inventive programs and transfer means such as, for example, network components that transfer the programs can be embodiments of the invention.

1-27. (canceled)

28. A method for conversion of an input document data stream that corresponds to one of many possible input data formats into an output document data stream that corresponds to one of many possible input data formats, comprising the steps of:
converting the input document data stream into an internal data format;
adding as needed document formatting information that establishes a representation of the data in the output format to the data in the internal data format; and
converting the data into the output data format.

29. A method according to claim 28 wherein for conversion of the input document data stream into the output document data stream that corresponds to one of many possible input data formats the input document data stream is converted into an internal data format, document formatting information that establishes how a content of the data stream in the internal data format is represented in the output data format is added as needed, controlled by a document template, to the data in the internal data format, and the data are output in the output data format.

30. A method according to claim 28 wherein the input document data stream is converted into an internal data format with formatted data that contain format specifications and raw data that contain no format specifications for format-adapted and speed-optimized processing of the input document data stream.

31. A method according to claim 30 wherein formatting data are added to the raw data by means of predetermined rules and an output data stream that has a predetermined format is formed from the data of the internal data format.

32. A method according to claim 29 wherein the document template is formed using a design data set and the conversion into the internal data format occurs via rules that use the design data set.

33. A method according to claim 29 wherein the document template is generated using free programmed static or dynamic elements.

34. A method according to claim 28 wherein types are associated per field with a design data set in a first preparatory design phase, whereby formatting instructions are associated with a first type group and no formatting is associated with a second type group, and whereby in a second, productive processing phase all data sets of the input document data stream are examined by type, and data that are associated with the first type group are additionally formatted and data that are associated with the second type group receive no additional formatting.

35. A method according to claim 28 wherein a freely definable rule file is formed in a design phase, mapping rules of which rule file are automatically derived or derived such that they are freely editable from the design set, from the input document data, or from other rules from auxiliary files.

36. A method according to claim 33 wherein assembly of formatting rules occurs during a design time.

37. A method according to claim 28 wherein formatted data are converted into a device-specific output data format.

38. A method according to claim 28 wherein a normalized data stream or a formatted data stream are device-specifically optimized in the processing.

39. A method according to claim 28 wherein the input data format, the output data format, or the document formatting information to be added are selectable.

40. A method according to claim 28 wherein pre-formatted data are processed in a first formatting stage and raw data are processed in a second processing state.

41. A method according to claim 40 wherein the raw data are used multiple times in components in the second processing stage.

42. A method according to claim 41 wherein a component comprises graphical elements or indexing information.

43. A method according to claim 28 wherein the document formatting information comprises paper reproduction information.

44. A method according to claim 28 wherein the document formatting information comprises print pre- or post-processing information.

45. A method according to claim 28 wherein the input data stream comprises an SAP/RDI data stream, a line data data stream, or a metacode data stream.

46. A method according to claim 28 wherein the output document data stream comprises an Advanced Function Presentation data stream in which a first group of formatting information is provided via a pagedef file and a second group of formatting information is contained in the input document data stream or in a normalized raw data stream.

47. A method according to claim 28 wherein activation signals for a display medium or a computer comprising a display medium are formed from a normalized output document data stream.

48. A method according to claim 28 wherein the output document data stream is represented on a display medium, and can be edited such that effected changes change a document template and thus retroact on an unrastered output document data stream.

49. A method according to claim 28 wherein the output document data stream is output to an e-mail system, a fax device, or an Internet server.

50. A system for conversion of an input document data stream corresponds to one of many possible input data formats into an output document data stream that corresponds to one of many possible input data formats, comprising:
a first converter which converts the input document data stream into an internal data format;
document formatting information that establishes a representation of the data in the output format to the data in the internal data format; and
a second converter which converts the data into the output data format.

51. A system of claim 50 comprising a data processing system.

52. A system of claim 50 comprising a data processing printing system.

53. A computer program product for conversion of an input document data stream that corresponds to one of many possible input data formats into an output document data stream that corresponds to one of many possible input data formats, said computer program product
converting the input document data stream into an internal data format;
adding as needed document formatting information that establishes a representation of the data in the output format to the data in the internal data format; and
converting the data into the output data format.
